(19) United States
(12) Patent Application Publication
(10) Pub. No.: US 2026/0009476 A1
(43) Pub. Date: Jan. 8, 2026

(54) CHECK VALVE, METHOD OF OPERATING A CHECK VALVE AND SOLENOID ASSEMBLY

(71) Applicant: Robert Bosch GmbH, Stuttgart (DE)

(72) Inventors: Marco Beier, Rudolstadt (DE); Andreas Rau, Stuttgart (DE); Axel Schnaufer, Stuttgart (DE); Daniel Fischer, Stuttgart (DE); Joachim Soubari, Ettlingen (DE)

(21) Appl. No.: 18/993,619

(22) PCT Filed: Jul. 3, 2023
(86) PCT No.: PCT/EP2023/068233

§ 371 Date: Jan. 13, 2025

(30) Foreign Application Priority Data
Aug. 3, 2022 (DE) 10 2022 208 069.6

(51) Int. Cl. F16K 31/06; F16K 39/02

(52) U.S. Cl. CPC F16K 31/0658; F16K 31/0675; F16K 31/0682; F16K 39/02

(57) ABSTRACT

The invention relates to a check valve (1) having a solenoid assembly (2), which comprises a solenoid actuator (12) having a solenoid (6) and an armature (7), which is pre-tensioned by a spring element (9) with a pre-tensioning force acting in a closing direction, wherein the armature (7) is movable along an axis of movement (10) in an opening direction to open the check valve (1) via a magnetic flux acting against the pre-tensioning force of the spring element (9), to open a fluidic connection between a fluid inlet (4) and a fluid outlet (5), which is blocked without the magnetic force, by a magnetic force pulling on the armature (7).

In order to functionally improve the check valve (1), the solenoid assembly (2) is designed in such a way that a selectively asymmetric magnetic force distribution results with respect to the axis of movement (10) of the armature (7).

### BACKGROUND

The invention relates to a check valve having a solenoid assembly, which comprises a solenoid actuator having a solenoid and an armature, which is pre-tensioned by a spring element with a pre-tensioning force acting in a closing direction, wherein the armature is movable along an axis of movement in an opening direction to open the check valve via magnetic flux against the pre-tensioning force of the spring element, to open a fluidic connection between a fluid inlet and a fluid outlet, which is blocked without the magnetic flux, by a magnetic force pulling on the armature. The invention further relates to a method for operating such a check valve as well as a solenoid assembly, in particular a single part of a solenoid assembly, for such a check valve. The check valve is preferably a safety solenoid valve, also referred to as a shut-off valve.

A device for storing compressed gas, for example hydrogen or natural gas, comprising a storage line to which at least one compressed gas tank is connected, wherein a safety solenoid valve also referred to as a shut-off valve is integrated into the storage line, is known from the German patent application DE 10 2020 201 172 A1.

### SUMMARY

The object of the invention is to functionally improve a check valve according to the disclosure.

The object is solved by a solenoid assembly designed such that a magnetic force distribution which is asymmetrical in relation to the axis of movement of the armature results, with a check valve having a solenoid assembly, which comprises a solenoid actuator having a solenoid and an armature, which is pre-tensioned by a spring element with a pre-tensioning force acting in a closing direction, wherein the armature is movable along an axis of movement in an opening direction to open the check valve via magnetic flux against the pre-tensioning force of the spring element, to open a fluidic connection between a fluid inlet and a fluid outlet, which is blocked without the magnetic flux, by a magnetic force pulling on the armature. Due to the asymmetrical magnetic force distribution, large pressure differences and flows through the opened fluidic connection can be realized with only one sealing seat and only one solenoid actuator. The solenoid force applied to the armature to open the check valve is a pulling force. Particularly advantageously, a tilting of the armature is effected during opening due to the asymmetric magnetic force distribution. Thus, the solenoid actuator of the check valve may also be referred to as a tilt-pull actuator.

A preferred exemplary embodiment of the check valve is characterized in that the armature movable along its axis of movement can also be tilted by the asymmetric magnetic force distribution relative to its axis of movement. The tilting of the armature can be realized, for example, by a correspondingly large guide clearance between the armature and a guide geometry. The solenoid force for opening the check valve advantageously does not act centrally on the armature in the axis of movement. The magnetic force advantageously acts laterally offset from the axis of movement. As a result, a torque is applied to the armature when the check valve is opened via the asymmetrical magnetic force distribution. This torque causes the armature to tilt as desired when opening the check valve. The asymmetrical magnetic force distribution may be realized in various parts of the solenoid assembly.

A further preferred exemplary embodiment of the check valve is characterized in that the armature guided in a guide geometry along its axis of movement has a convex armature boundary surface which faces the guide geometry and allows a desired tilting movement of the armature when the armature is exposed to the asymmetrically acting magnetic force. The guide geometry for the armature is designed, for example, as a straight circle cylinder jacket. Due to the convex armature boundary surface, the armature, which otherwise essentially has the design of a circular washer or a circular cylinder, has a spherical contour. The armature is preferably designed to be rotationally symmetrical relative to its axis of movement, also referred to as the armature axis. At its ends, for example, the anchor is bounded by circular surfaces.

A further preferred exemplary embodiment of the check valve is characterized in that the armature has an asymmetrical shape relative to its axis of movement. Due the asymmetrical configuration of the armature, the magnetic force does not act centrally in the armature axis but laterally offset and thus generates a torque on the armature. This easily allows the armature to perform the desired tilting movement when the check valve is opened.

Another preferred exemplary embodiment of the check valve is characterized in that the armature has at least one material recess for realizing the asymmetrical magnetic force distribution when opening the check valve. The material recess may be designed as a step or flattening at one end of the armature. The material recess may also comprise at least one depression on a side of the armature. The recess may be round or rectangular. The size and shape of the material recess, and optionally also the number of multiple material recesses, are designed with regard to the asymmetry of the magnetic force when opening the check valve.

A further preferred exemplary embodiment of the check valve is characterized in that the material recess is provided in an end face of the armature facing an opposite pole of the solenoid assembly. The desired asymmetry of the magnetic force can thus be easily realized during manufacturing.

Another preferred exemplary embodiment of the check valve is characterized in that the check valve has a central outlet channel and a decentral inlet channel. The terms decentral and central refer to the axis of movement of the armature. Central means in particular that the outlet channel is arranged coaxially to the axis of movement. Decentral, on the other hand, means that the inlet channel is parallel or oblique to the axis of movement of the armature. The arrangement of the outlet channel and the inlet channel have proven advantageous with respect to the desired tilting movement of the armature when opening the check valve. It is particularly advantageous that flow forces support or improve the tilting movement of the armature initiated by the asymmetric magnetic force distribution by the fluid connection opened when the armature is tilted.

Another preferred exemplary embodiment of the check valve is characterized in that the check valve is designed as a seat valve with a closed position, in which the armature is symmetrically arranged relative to its axis of movement. With the check valve closed, the armature or a closing element coupled to the armature is symmetrically brought to the closed position or kept in the closed position by the pre-tensioning force of the spring element and by a differential pressure acting on the armature or the closing element coupled to the armature. Thus, undesirable opening of the check valve in operation is safely prevented.

In a method for operating a check valve as described above, preferably in a fuel cell system, the above-mentioned task is alternatively or additionally solved by the armature being tilted by the asymmetric magnetic force distribution when the check valve is opened in order to realize a greater flow of fluid. The greater fluid flow is advantageously realized with only one sealing seat and with only one solenoid actuator.

The invention also relates, where applicable, to a fuel cell system with a check valve as described above. The check valve is advantageously disposed in an anode path of the fuel cell system.

The invention also relates, where applicable, to a solenoid assembly, in particular a single part of a solenoid assembly, preferably an armature, for a check valve as described above. The mentioned parts can be procured separately.

Further advantages, features, and details of the invention arise from the following description, in which exemplary embodiments are described in detail with reference to the drawings.

### BRIEF DESCRIPTION OF THE DRAWINGS

Shown are:

FIG. 1 a schematic longitudinal section diagram of a check valve having a solenoid assembly comprising a tiltable armature; the

FIGS. 2 to 4, three exemplary embodiments of the armature of FIG. 1, each in a front view and in a top view;

FIG. 5 schematic diagrams of the solenoid assembly of FIG. 1 with various arrows to illustrate the function of the check valve with the armature tilting when opened; and

FIG. 6 a schematic diagram of a typical fuel cell system.

### DETAILED DESCRIPTION

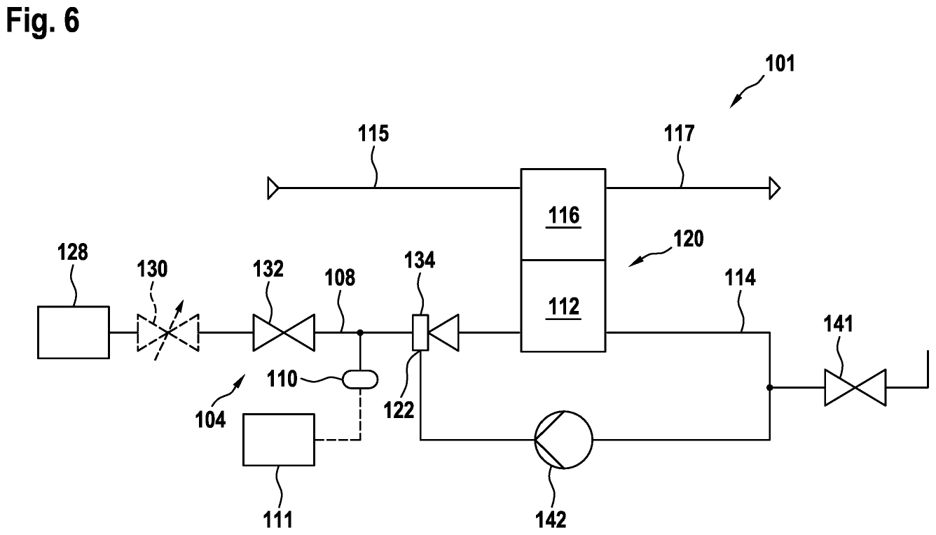

FIG. 6 shows a schematic diagram of a method of a typical fuel cell system 101. The fuel cell system 101 includes an anode path 104 connecting a hydrogen tank 128 to an anode 112 of a fuel cell stack 120. At least two valves 132, 134 are disposed within the anode path 104.

The first valve 132 is configured as a check valve or a shut-off valve 132. The shut-off valve 132 is open when the fuel cell system 101 is in operation. When the fuel cell system 101 is shut down, the shut-off valve 132 is closed so that hydrogen from the hydrogen tank 128 can no longer flow to the anode 112.

The second valve 134 is designed as an HGI valve 134 and can dose the amount of hydrogen required depending on the respective operating state of the fuel cell stack 120, to the anode 112.

A connecting line 108 is arranged between the check valve 132 and the second valve 134. A sensor 110 which can determine the pressure within the connecting line 108 is located in the connecting line 108.

The hydrogen is typically stored in the hydrogen tank 128 at high pressure. In order to reduce the pressure, a pressure control valve 130 may be located between the hydrogen tank 128 and the first valve 132 and reduces the pressure before the hydrogen flows to the HGI valve 134 or to the anode 112. The pressure at the inlet of the first valve 132, which corresponds to the tank pressure or was reduced by the pressure control valve 130, is referred to as the supply pressure.

The fuel cell system 101 furthermore comprises a cathode gas supply line 115, which supplies air to a cathode 116 of the fuel cell stack 120, and a cathode gas discharge line 117 which discharges the consumed air and exhaust gases from the fuel cell stack 120.

When the fuel cell system 101 is in operation, hydrogen is delivered to the anode path 104 via the hydrogen tank 128, the first valve 132, and via the second valve 134 to the anode 112. Since the hydrogen is hyperstoichiometrically fed to the anode 112 for performance and component protection reasons, the unconsumed hydrogen is fed back via an anode gas return line 114 and fed back into the anode path 104 at a hydrogen return point 122.

A recirculation pump 142 and other valves and components may be disposed within the anode gas return line 114.

Since, during the fuel cell reaction, nitrogen diffuses from the cathode 116 to the anode 112 and accumulates with increasing proportion within the anode path 104 via the anode gas return line 114, the nitrogen accumulated within the anode path 104 must be removed from the fuel cell system 101 from time to time.

This may take place via a purge valve 141 arranged in the anode gas return line 114. In order to discharge an excess of water from the anode 112 or the anode path 104, a water separator, a water reservoir and a drain valve, which are not explicitly shown in the drawing since they are not essential to the invention, can further be arranged within the anode gas return line 114.

The fuel cell system 101 comprises a measuring assembly for checking at least one valve 132, 134. The measuring assembly comprises a sensor 110 for detecting measured values for determining a current pressure at a position within the connecting line 108 of the anode path 104. In an alternative embodiment, the sensor 110 may also sense the current temperature of the gas at that position.

A controller 111 is connected to the sensor 110 in a wired or wireless manner to sense readings, particularly pressures and/or temperatures and evaluate them according to the method of the invention to check for leakage of the first valve (shut-off valve) 132 or the second valve (HGI valve) 134.

The control unit 111 is also connected to further components of the fuel cell system 101. The control unit 111 may also be connected to the first valve 132 and/or second valve 134 to sense the timing of opening and closing of the first valve 132 and second valve 134 and to include these in the calculation of a leakage rate.

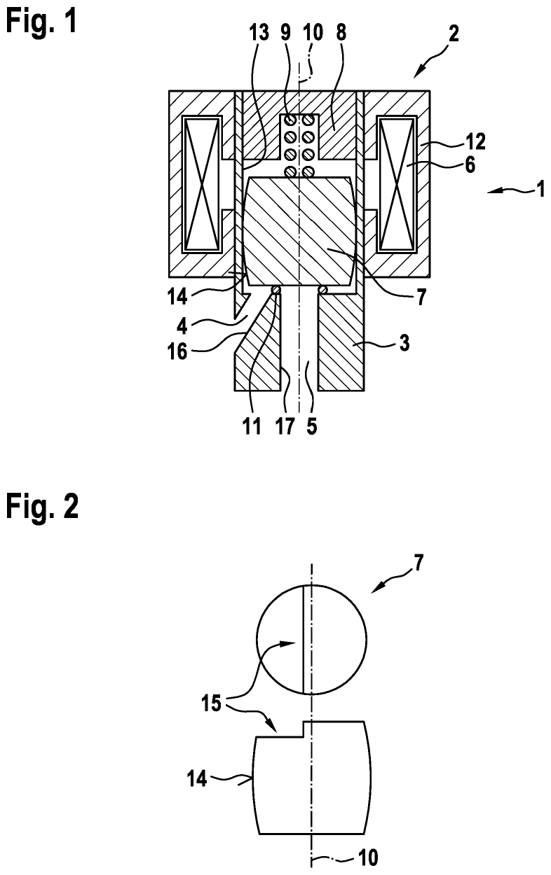

FIG. 1 shows a schematic longitudinal section of a check valve 1. The check valve 1 may also be referred to as a shut-off valve. For example, the check valve 1 is a shut-off valve as designated in FIG. 6 with 132.

The check valve 1 is used in a hydrogen system, in particular in a fuel cell system, to controllably and securely seal a tank system when shutting it down, for example in an emergency. Depending on the operating state, high pressure differences and high flow rates can occur, which must be quickly interrupted with the check valve 1.

FIGS. 1 to 5 illustrate how a fast and stable closing can be ensured even with a maximum pressure difference and a maximum flow when the check valve 1 is open in a predetermined design space and/or at the maximum available supply energy.

Advantageously, the check valve 1 comprises only one sealing seat 11 and only one solenoid actuator 12. Advantageously, even large pressure differences and flows can be realized when the opened check valve 1 is in operation with the one sealing seat 11 and the one solenoid actuator 12.

The check valve 1 comprises a solenoid assembly 2 having a pole tube 3, a solenoid 6, an armature 7 and an opposing pole 8. The armature 7 can be moved back and forth along an axis of movement 10 in a translational manner, that is to say, up and down in FIG. 1. The armature 7 is pre-tensioned away from the opposite pole 8 By a spring element 9, that is to say, downwards in FIG. 1.

A fluid inlet 4 and a fluid outlet 5 are designated at the lower end of the pole tube 3 in FIG. 1. For example, the fluid outlet 5 comprises a central outlet channel 17. The central outlet channel 17 is arranged coaxially to the axis of movement 10 of the armature 7, also referred to as the armature axis 10. The fluid inlet 4 comprises a decentral inlet channel 16. The inlet channel 16 is oblique to the armature axis 10.

A sealing seat 11 is indicated in FIG. 1 by two circles. The sealing seat 11 is closed by the armature 7. Of course, the armature 7 can also be combined with an actuator and/or closing body. In the schematic diagram, it is essentially important that the sealing seat 11 is retained in its closed state as shown in FIG. 1 by a spring pre-tensioning force of the spring element 9, which applies a downward impact to the armature 7 in FIG. 1.

When the flow passes by the solenoid 6 of the solenoid actuator 12, the armature 7 in FIG. 1 is pulled upward, wherein a fluid passageway between the fluid inlet 4 and the fluid outlet 5 is opened at the sealing seat 11. With the check valve 1 open, the armature 7 is pulled upwardly by a magnetic flux or magnetic circuit not shown in FIG. 1 of the solenoid assembly 2 in FIG. 1. Thus, the magnetic actuator 12 may also be referred to as the pulling magnetic actuator 12.

However, according to a substantial aspect of the invention, the armature is movably guided in the pole tube 3 not only in the axial direction, that is to say, up and down in FIG. 1. The armature 7 comprises a convex armature boundary surface 14 that allows the armature 7 to be tilted in a guide geometry 13 of the pole tube 3. The guide geometry 13 is designed as a straight circle cylinder jacket.

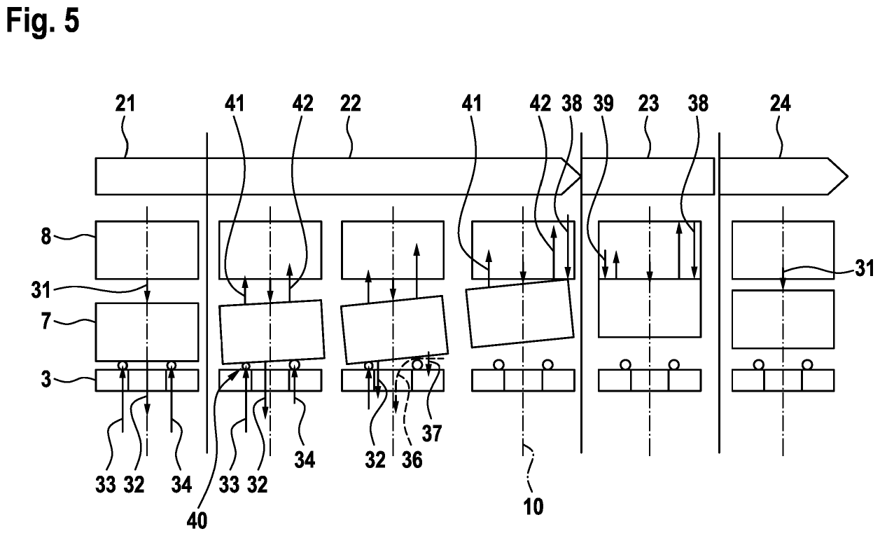

The armature 7 is substantially designed as a straight circle cylinder, wherein the armature 7 has a barrel shape due to the convex armature boundary surface 14. The armature 7 is radially rotatable about its center point by the convex armature boundary surface 14, at least to a limited extent. This radial rotation, also described as a tilting, is illustrated in FIG. 5.

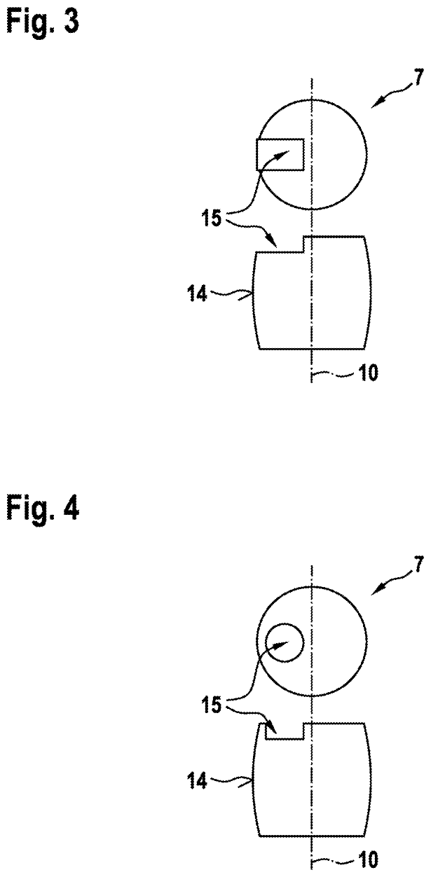

FIGS. 2 to 4 show how an asymmetric design of the armature 7 achieves that the magnetic force generated by the solenoid assembly 2 when the check valve 1 is opened does not act centrally in the armature axis 10 but is laterally offset and thus generates a torque on the armature 7. The asymmetry of the magnetic force does not necessarily have to be realized in the armature 7, but can also be taken into consideration in other parts of the magnetic assembly 2, for example in the opposite pole 8 or in the exciter system of the solenoid assembly 2 with the solenoid 6.

FIGS. 2 to 4 show how the asymmetry of the magnetic force can be realized with the help of a targeted change in the geometry of the armature 7. The armature 7 is provided with a material recess 15 to realize the asymmetry of the magnetic force. The material recess 15 can be designed differently. It is essential that the material recess 15 imparts an asymmetric shape to the armature 7 with respect to the armature axis 10.

In FIG. 2, the material recess 15 is embodied as a flat section. In FIG. 3, the material recess 15 is embodied as a rectangular recess. In FIG. 4, the material recess 15 is embodied as a circular recess.

In FIG. 5, the operation of the check valve 1 is illustrated. A force distribution in the closed state of the check valve is represented under a rectangular symbol 21. The force distribution when opening the check valve is represented under an arrow symbol 22. The force distribution in the open state of the check valve is represented under a rectangular symbol 23. The force distribution when closing the check valve is represented under an arrow symbol 24.

An arrow 31 shows a spring force of the spring element designated in FIG. 1 with 9. An arrow 32 shows a differential pressure force, which is generated by different pressures in the fluid inlet 4 and in the fluid outlet 5 and acts on the armature 7. Arrows 33 and 34 show left and right bearing forces. Arrows 41 and 42 indicate magnetic forces generated by the solenoid assembly 2 for opening the check valve on the armature 7.

The basic idea behind the principle of operation of the check valve illustrated in FIG. 5 is borrowed from opening a jar. For the simplified illustration of FIG. 5, the forces are divided into a left and a right half, respectively. In reality, these are annular surfaces and consequently, of course, annular forces.

When the check valve is closed, the spring element, which is also referred to simply as a spring, symmetrically pushes the armature 7 into its sealing seat with its spring force 31 and the differential pressure force 32, which is also referred to simply as a seat. The symmetry in the closed state causes the left bearing force 33 and the right bearing force 34 to be equal and results in a central point of application for the differential pressure force 32.

When the flow passes by the solenoid, which is also referred to simply as the coil, magnetic flux builds up through the armature 7. The magnetic flux leads to a magnetic force 41, 42 being built up via a working air gap in the opposite pole of the solenoid assembly. However, due to the asymmetry of the armature 7, the magnetic force 41, 42 does not act on the armature 7 centrally, but rather with a torque, as indicated in FIG. 5 below the arrow symbol 22 by the arrows 41 and 42 of different lengths.

The torque causes the armature 7 to tilt, thereby relieving the load on the right side of the seat in FIG. 5. This is indicated by the arrows 33 and 34 of different lengths in FIG. 5 under the arrow symbol 22. In FIG. 5, the point at which the differential pressure force 32 is applied moves to the left, towards a tilting point or a tilt axis at the sealing seat. The tilting point is designated as 40 in FIG. 5.

If the tilting of the armature 7 is so strong that the seat on the one hand leaks, gas flows from a tank through the fluid inlet and fluid outlet into a downstream system as indicated in FIG. 5 under arrow symbol 22 in the middle by a dashed arrow 36. This in turn leads to a reduction in the pressure differential and thus the differential pressure force, as indicated in FIG. 5 by an arrow 37 and the arrow 32.

If the sum of the differential pressure force 32 and the spring force 31 is less than or equal to the total axial magnetic force 41, 42, then the armature 7 moves towards the opposite pole 8. When the armature 7 impacts the opposite pole 8, it also results in a tilting point there, which is indicated by an arrow 38 in FIG. 5 under the arrow symbol 22 on the right.

Because this tilting point is ideally outside of the magnetic force actuation points of the magnetic forces 41, 42, the magnetic forces 41, 42 rotate the armature 7 back into its armature axis 10, opposite to the previous rotational movement. When closing, the spring acts centrally on the armature 7 once again, as illustrated in FIG. 5 below the arrow symbol 24. Without the magnetic force, the armature 7 is moved downwards with the solenoid assembly in FIG. 5 switched off and closes the sealing seat.

1. A check valve (1) including a solenoid assembly (2), which comprises a solenoid actuator (12) having a solenoid (6) and an armature (7), which is pre-tensioned by a spring element (9) with a pre-tensioning force acting in a closing direction, wherein the armature (7) is movable along an axis of movement (10) in an opening direction to open the check valve (1) via a magnetic force against the pre-tensioning force of the spring element (9), to open a fluidic connection between a fluid inlet (4) and a fluid outlet (5), which is blocked without the magnetic force, by a magnetic force pulling on the armature (7), wherein the solenoid assembly (2) is designed in such a way that a purposefully asymmetrical magnetic force distribution results relative to the axis of movement (10) of the armature (7).

2. The check valve of claim 1, wherein the armature (7) movable along its axis of movement (10) can also be tilted by the asymmetric magnetic force distribution relative to its axis of movement (10).

3. The check valve according to claim 2, wherein the armature (7) guided in a guide geometry (13) along its axis of movement (10) comprises a convex armature boundary surface (14) which faces the guide geometry (13) and allows a desired tilting movement of the armature (7) when the armature (7) is exposed to the asymmetrically acting magnetic force.

4. The check valve according to claim 1, wherein the armature (7) has an asymmetrical shape relative to its axis of movement (10).

5. The check valve of claim 3, wherein the armature (7) comprises at least one material recess (15) for realizing the asymmetric magnetic force distribution when the check valve (1) is opened.

6. The check valve of claim 5, wherein the material recess (15) is provided in an end face of the armature (7) facing an opposing pole (8) of the solenoid assembly (2).

7. The check valve of claim 1, wherein the check valve (1) comprises a central outlet passage (17) and a decentral inlet passage (16).

8. The check valve according claim 1, wherein the check valve (1) is designed as a seat valve with a closed position in which the armature (7) is symmetrically arranged relative to its axis of movement (10).

9. A method of operating a check valve (1) according to claim 1, wherein the armature (7) is tilted by the asymmetric magnetic force distribution when the check valve (1) is opened to realize a greater flow of fluid.

10. A solenoid assembly (2) for a check valve (1) according to claim 1.
